(19) United States
(12) Patent Application Publication
(10) Pub. No.: US 2025/0379768 A1
(43) Pub. Date: Dec. 11, 2025

(54) POWER EFFICIENT BIDIRECTIONAL DIE-TO-DIE COMMUNICATION SYSTEMS AND METHODS

(71) Applicant: Microsoft Technology Licensing, LLC, Redmond, WA (US)

(72) Inventors: Charles Walter BOECKER, Ames, IA (US); Eric Douglas GROEN, Ankeny, IA (US); Shankar Srinivasa TANGIRALA, Mountain View, CA (US); Ravi SHIVNARAINE, Pickering (CA)

(21) Appl. No.: 18/739,939

(22) Filed: Jun. 11, 2024

(51) Int. Cl. H04L 25/02; G06F 1/3237

(52) U.S. Cl. CPC H04L 25/0278; G06F 1/3237; H04L 25/0294

(57) ABSTRACT

Systems and methods for bidirectional communication between a first die and a second die using a shared route are described. The method includes, during a first phase of operation, allowing bidirectional communication between the first die and the second die using the shared route. The method further includes, during a second phase of operation: (1) pausing bidirectional communication between the first die and the second die using the shared route, (2) parking the first transmit driver by coupling an input terminal of the first transmit driver to a voltage level, and (3) parking the second transmit driver by coupling an input terminal of the second transmit driver to the same voltage level, where the voltage level is one of a voltage supply level or a ground level. Additional systems and methods for clock gating of signals that make the bidirectional communication even more efficient are also described.

### BACKGROUND

Die-to-die (D2D) links are an integral aspect of advanced packaging technologies, including packaging technologies for integrating separate dies into multi-die systems. Example topologies of integrated dies include horizontally integrated dies (e.g., chiplets in a plane) and vertically-integrated dies (e.g., 2.5D, 3D, and silicon bridge topologies). A large monolithic chip, e.g., a system on chip (SoC) can be split into multiple smaller dies, which are referred to as chiplets. Die-to-Die (D2D) links are used to integrate portions (located on separate chiplets/dies) of large systems, such as SoCs, into a single system.

Many such systems require high data rate bidirectional communication between separate dies or chiplets associated with such systems. Such high data rate bidirectional communication can be enabled by transceivers that can use non-return-to-zero (NRZ) modulation. Alternatively, such transceivers can also use phase modulation schemes, including three-level pulse amplitude (PAM3) modulation or four-level pulse amplitude (PAM4) modulation. Regardless of the modulation scheme, there remains a need for power efficient bidirectional die-to-die communication systems and methods.

### SUMMARY

In one example, the present disclosure relates to a method for bidirectional communication between a first die and a second die in a multi-die system. The first die may comprise a first transmit driver coupled to a first node of a shared route between the first die and the second die, and the second die may comprise a second transmit driver coupled to a second node of the shared route. The method may include, during a first phase of operation, allowing bidirectional communication between the first die and the second die using the shared route.

The method may further include during a second phase of operation: (1) pausing bidirectional communication between the first die and the second die using the shared route, (2) parking the first transmit driver by coupling an input terminal of the first transmit driver to a voltage level, and (3) parking the second transmit driver by coupling an input terminal of the second transmit driver to the same voltage level, where the voltage level is one of a voltage supply level or a ground level.

In another example, the present disclosure relates to a method for bidirectional communication between a first die and a second die in a multi-die system. The method may include a first receive link macro within the first die, receiving a first clock gating signal from a second transmit link macro within the second die, where the first clock gating signal is coupled to a first clock gating logic circuit, allowing selective disabling of a first receive clock associated with the first receive link macro.

The method may further include a second receive link macro within the second die, receiving a second clock gating signal from a first transmit link macro within the first die, where the second clock gating signal is coupled to a second clock gating logic circuit, allowing selective disabling of a second receive clock associated with the second receive link macro.

In yet another example, the present disclosure relates to a method for bidirectional communication between a first die and a second die in a multi-die system. The first die may comprise a first transmit driver coupled to a first node of a shared route between the first die and the second die and a first clock driver for driving a first clock signal, and the second die may comprise a second transmit driver coupled to a second node of the shared route and a second clock driver. The method may include, during a first phase of operation, allowing bidirectional communication between the first die and the second die using the shared route.

The method may further include during a second phase of operation: (1) pausing bidirectional communication between the first die and the second die using the shared route, (2) parking the first transmit driver by coupling an input terminal of the first transmit driver to a voltage level, (3) parking the second transmit driver by coupling an input terminal of the second transmit driver to the same voltage level, where the voltage level is one of a voltage supply level or a ground level, (4) parking the first clock driver by coupling an input terminal of the first clock driver to the same voltage level, and (5) parking the second clock driver by coupling an input terminal of the second clock driver to the same voltage level.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 shows an example multi-die system with power efficient bidirectional communication;

FIG. 2 shows a system associated with one shared route (e.g., an interposer route or a package route) of the multi-die system of FIG. 1 with power efficient bidirectional communication;

FIG. 3 is an example D2D link macro for use with power efficient bidirectional die-to-die communication;

FIG. 4 shows a block diagram of an example D2D transmit link macro for use with power efficient bidirectional die-to-die communication systems and methods;

FIG. 5 shows a block diagram of an example D2D receive link macro for use with power efficient bidirectional die-to-die communication systems and methods;

FIGS. 6 and 7 show a block diagram of a power efficient bidirectional die-to-die communication system with parking of transmit drivers and clock drivers;

FIG. 8 shows an example set of transmit link macros with clock gating for use with power efficient bidirectional die-to-die communication systems and methods;

FIG. 9 shows an example set of receive link macros with clock gating for use with power efficient bidirectional die-to-die communication systems and methods;

FIG. 10 shows waveform diagrams associated with a transmit side of a power efficient bidirectional die-to-die communication system;

FIG. 11 shows waveform diagrams associated with a receive side of a power efficient bidirectional die-to-die communication system;

FIG. 12 shows a flow chart of an example method for power efficient bidirectional communication between dies in a multi-die system; and

FIG. 13 shows another flow chart of an example method for power efficient bidirectional communication between dies in a multi-die system.

### DETAILED DESCRIPTION

Examples described in this disclosure relate to power efficient bidirectional die-to-die communication systems and methods. Die-to-die (D2D) links are an integral aspect of advanced packaging technologies, including packaging technologies for integrating separate dies into multi-die systems. Example topologies of integrated dies include horizontally integrated dies (e.g., chiplets in a plane) and vertically-integrated dies (e.g., 2.5D, 3D, and silicon bridge topologies). A large monolithic chip, e.g., a system on chip (SoC) can be split into multiple smaller dies, which are referred to as chiplets. Die-to-Die (D2D) links are used to integrate portions (located on separate chiplets/dies) of large systems, such as SoCs, into a single system. As used herein the term “die” includes any block of material (e.g., semiconducting material or other types of materials used in manufacturing of integrated circuits on a shared substrate) having integrated circuits, where the die can be packaged. The term “dies” includes chiplets, which are typically smaller than a die.

Conventional D2D links transmit data in a single direction or use a turn-around bus like the double-data rate (DDR) standard. Transmitting only one direction, however, reduces the bandwidth that an interface can support. Thus, the D2D links described herein use a bidirectional bus to enable signaling in both directions simultaneously. This increases the bandwidth that the D2D transmit/receive macros described herein can support because each macro can transmit and receive at the same time, resulting in twice the amount of bandwidth for the same frequency signals. Many such systems require high data rate bidirectional communication between separate dies associated with such systems. Such high data rate bidirectional communication can be enabled by transceivers that can use non-return-to-zero (NRZ) modulation. Alternatively, such transceivers can also use phase modulation schemes, including three-level pulse amplitude (PAM3) modulation or four-level pulse amplitude (PAM4) modulation. Regardless of the modulation scheme, there remains a need for power efficient bidirectional die-to-die communication systems and methods.

In certain examples described herein the interfaces associated with the bidirectional D2D links (e.g., D2D links that can communicate between two dies in both directions at the same time using a single trace) are clock gated to save power. As an example, the interface goes to sleep in the same state on both sides to ensure the lowest power state. Each end of the D2D link parks the output at the same level to ensure any power usage of the interface (not being used for any transmission or reception) is minimized. In addition, the interfaces described herein can use simplified echo cancellation to improve performance of the bidirectional D2D links.

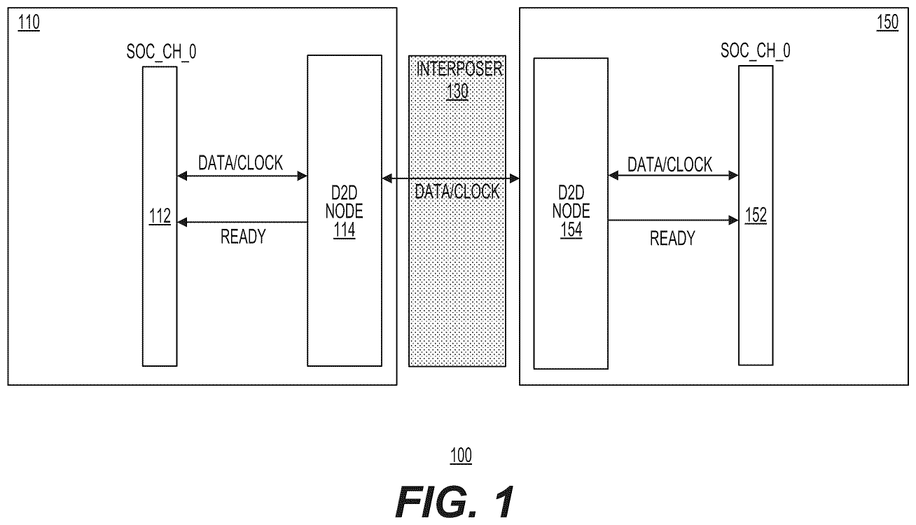

FIG. 1 shows an example multi-die system 100 with power efficient bidirectional communication. The block diagram for multi-die system 100 shown in FIG. 1 illustrates the logical aspects of the use of the D2D serialized links in the context of multi-die systems, such as the multi-die system 100. Multi-die system 100 includes a die 110 coupled with another die 150 using an interposer 130. To illustrate the power efficient bidirectional communication, only certain aspects of each die are highlighted. Die 110 includes D2D node 114 and die 150 includes D2D node 154. The purpose of each of the D2D nodes is to transport the contents of a bus included within a die to another bus included in another die. Die 110 includes a system-on-chip (SoC) channel 112 (SOC_CH_0), which is coupled to a D2D node 114, located within die 110. SoC channel 112 can provide data, clock, and valid signals to D2D node 114. SoC channel 112 can also receive data, clock, and valid signals from D2D node 114. D2D node 114 can transmit the data, along with a clock signal, to D2D node 154 located within die 150 via interposer 130. D2D node 114 can also receive data, along with a clock signal, from D2D node 154 within die 154 via interposer 130. The SoC channel 112 can receive control signals (e.g., READY) from D2D node 114. In this example, interposer 130 can be implemented as a passive interposer. Interposer 130 may be implemented as a silicon interposer or as an organic interposer.

With continued reference to FIG. 1, die 150 includes a system-on-chip (SoC) channel 152 (SOC_CH_0), which is coupled to a D2D node 154, located within die 150. SoC channel 152 can provide data, clock, and valid signals to D2D node 154. SoC channel 152 can also receive data, clock, and valid signals from D2D node 154. D2D node 154 can transmit the data, along with a clock signal, to D2D node 114 located within die 110 via interposer 130. D2D node 154 can also receive data, along with a clock signal, from D2D node 114 within die 110 via interposer 130. The SoC channel 152 can receive control signals (e.g., READY) from D2D node 154. For ease of explanation, in this example, the busses on the two dies are shown as identical in terms of their bandwidth (e.g., 390 bits). The principal function of the D2D nodes and the D2D links is to transport data from one die to the other die. Any number of SoC channels from die 110 can be transported across the die edge to the interposer 130 and then from the interposer to die 150, and vice-versa. Each D2D node can be viewed as a physical aggregation of components, where each of the components further includes sub-components. In this example, each D2D node includes one or more clusters of D2D link macros. Each D2D node can include D2D link macros that can provide transmit and receive functionality. Although FIG. 1 shows multi-die system 100 including a certain number of D2D nodes for enabling die-to-die communication, multi-die system 100 may include more or fewer such components, which could be arranged differently from the arrangement shown in FIG. 1. As an example, the interposer 130 is shown for interconnecting die 110 with die 150, other interconnection structures, including active interposers or other types of interconnection structures may also be used.

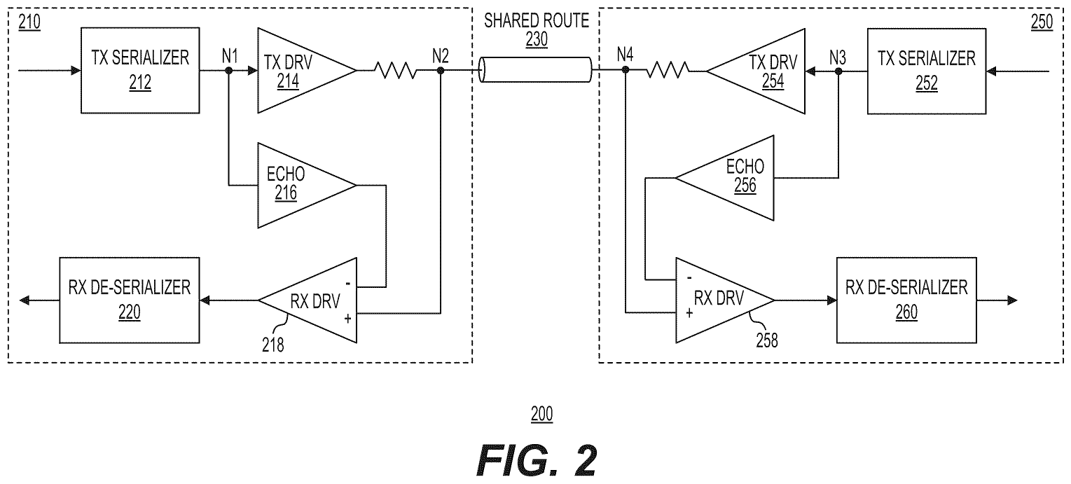

FIG. 2 shows a system 200 associated with one shared route (e.g., an interposer route or a package route) of the multi-die system 100 of FIG. 1 with power efficient bidirectional communication. System 200 includes a sub-system 210 associated with die 110 of FIG. 1, which is coupled via shared route 230 to a sub-system 250 associated with die 150 of FIG. 1. Sub-system 210 includes a TX serializer 212 for serializing data to be transmitted across the shared route 230. The TX serializer 212 is coupled via node N1 to a transmit driver (TX DRV 214), which in turn is coupled to the shared route 230 at node N2. One input of a receive driver (RX DRV 218) is coupled to the node N2, as well, for receiving any signals being from the shared route 230. The other input of the receive driver (RX DRV 218) is coupled to receive the output of an echo canceller (ECHO 216), which receives an input from node N1 (the same signal that is being transmitted by TX DRV 214). The output of the receive driver (RX DRV 218) is coupled to RX de-serializer 220. Sub-system 250 includes a TX serializer 252 for serializing data to be transmitted across the shared route 230. The TX serializer 252 is coupled via node N3 to a transmit driver (TX DRV 254), which in turn is coupled to the shared route 230 at node N4. One input of a receive driver (RX DRV 258) is coupled to the node N4, as well, for receiving any signals being from the shared route 230. The other input of the receive driver (RX DRV 258) is coupled to receive the output of an echo canceller (ECHO 256), which receives an input from node N3 (the same signal that is being transmitted by TX DRV 214). The output of the receive driver (RX DRV 258) is coupled to RX de-serializer 260.

With continued reference to FIG. 2, although signals are flowing in each direction on a single shared route in this case, since each side knows what it is sending on the shared route, each side can sense the line and subtract what it is sending to interpret what the other side is sending. In this example, echo cancellers on each side (e.g., echo 216 and echo 256) can cancel the transmitted signals. Thus, the signal at the micro bump is added with the negative (inverted version) of the transmitted signal. In order to best cancel the transmitted signal, the delay and the magnitude of each echo canceller needs to be calibrated. Once the echo canceller path is calibrated properly, the signal going to the receive data path is the signal being transmitted from the partner die.

Still referring to FIG. 2, in this example, the voltage level at the micro-bump (or similar structure) associated with a die is a four level signal. By superimposing rising and falling edges of non-return-to-zero (NRZ) signals being transmitted and received on the shared route, one can visualize the levels of variance for different signals. As an example, a signal analyzer (e.g., a signal integrity simulator or a similar tool) can be used to superimpose the rising and falling signal levels for the different signals to create an eye diagram (not shown). Simulated eye diagrams reveal that two levels in the middle of the eye diagram (not shown) have a delta. These two levels correspond to a situation when the two transmit drivers are in opposite states. The delta between these two different levels can be due to one or more factors. One of the factors relates to the mismatch in the driver impedance of the drivers on two different dies. The mismatch in the driver impedance may result from variations caused during the manufacturing (e.g., process mismatch) of the dies in one or more foundries. Another factor is the resistance associated with the shared route allowing the bidirectional communication between the two dies. Depending upon the length of the route, the resistance for the different shared routes can vary. The length of the shared route through an interposer, or another such structure, will vary depending on the location of the end-points (e.g., micro-bumps) that correspond to the shared route. Moreover, the routes themselves will have different lengths because of the routing and placement differences because of design rules, physical barriers, and other similar constraints.

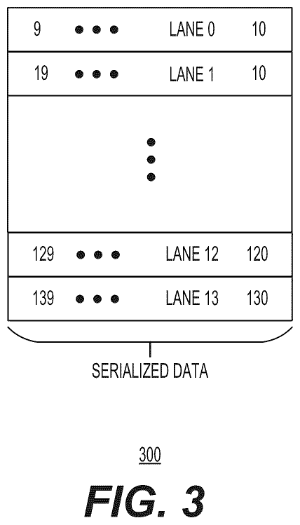

FIG. 3 is an example D2D link macro 300 for use with power efficient bidirectional die-to-die communication systems and methods. The physical D2D links between the two dies are implemented using a certain number of lanes per D2D link macro and serialization of the data across the D2D links. In this example, the D2D link macro 300 is capable of handling 10 bits per lane, which are then sent as serialized data across the physical D2D link, resulting in a serialization of 10:1. Example D2D link macro 300 is shown with fourteen lanes (LANE 0, LANE 1, . . . LANE 12, and LANE 13). Although FIG. 3 shows the D2D link macro 300 as having a certain number of lanes with a certain number of bits per lane, the D2D link macro 300 could have additional or fewer lanes with a different number of bits per lane.

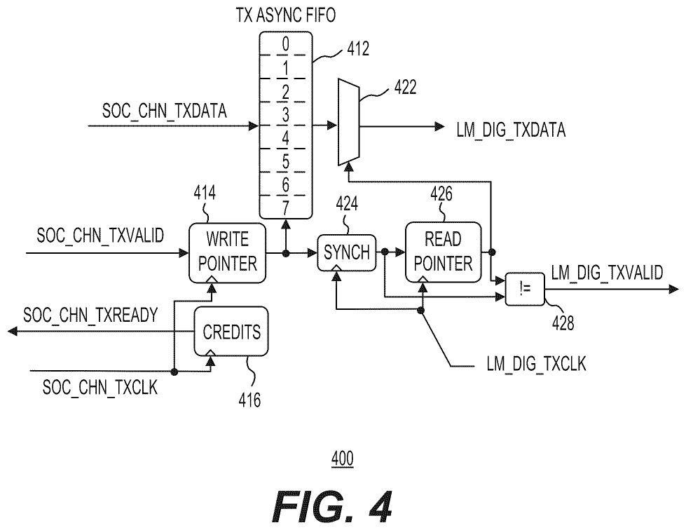

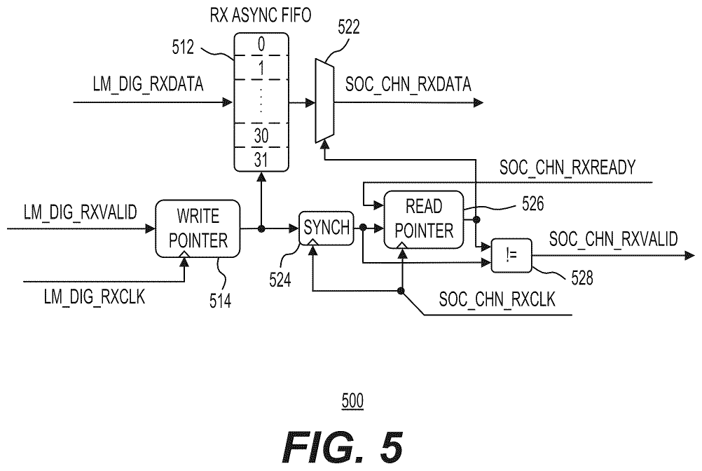

FIG. 4 shows a block diagram of an example D2D transmit link macro 400 for use with power efficient bidirectional die-to-die communication systems and methods. FIG. 5 shows a block diagram of an example D2D receive link macro 500 for use with power efficient bidirectional die-to-die communication systems and methods. As an example, D2D transmit link macro 400 could be implemented as the D2D link macro 200 of FIG. 2, which offers a capacity of 10-bits per lane and has 14 data lanes. In this example, D2D transmit link macro 400 is configured to process a system-on-chip (SoC) channel (e.g., a system bus associated with the SoC) with a bandwidth of a certain number of bits (e.g., 140 bits) and provide those for serialization. The serialized data is then transmitted via an interposer (or another packaging structure) to the receive side (shown in FIG. 5). The data output by the D2D transmit link macro 400 is serialized prior to the transmission using a serializer block (not shown). Table 1 below provides a brief explanation for the various signals (shown in FIG. 4) associated with the D2D transmit link macro 400.

TABLE 1

| D2D Transmit Link | |
|---|---|
| Marco Signals | Brief Explanation |
| SOC_CHN_TXDATA | Data for transmission from the pertinent SoC |
| | channel to the D2D transmit link macro. |
| SOC_CHN_TXVALID | Control signal for the write pointer from |
| | the pertinent SoC channel indicating valid |
| | transmit data. |
| SOC_CHN_TXCLK | Transmit clock associated with the pertinent |
| | SoC channel. |
| SOC_CHN_TXREADY | Ready signal from the D2D transmit link |
| | macro to the SoC channel. |
| LM_DIG_TXDATA | Data for transmission from the D2D transmit |
| | link macro, which is serialized, and then |
| | transmitted to another die. |
| LM_DIG_TXCLK | Transmit clock associated with the D2D |
| | transmit link macro. |
| LM_DIG_TXVALID | Control signal indicative of whether the |
| | transmit data is valid. |

With continued reference to FIG. 4, in this example, the D2D transmit link macro 400 includes a transmit asynchronous FIFO (TX ASYNC FIFO 412), which is used to receive the data to be transmitted (e.g., SOC_CHN_TXDATA of table 1). The D2D transmit link macro 400 further includes a write pointer 414, a block for managing flow using credits (e.g., CREDITS 416), a synchronization channel block (e.g., SYNCH 424), and a read pointer 426. The write pointer 414 points to the data in the TX ASYNC FIFO 412 and it advances through the FIFO once the write pointer 414 receives a valid signal (e.g., SOC_CHN_TXVALID of table 1). The write pointer 414 is synchronized with the read pointer 426 using the synchronization channel block (e.g., SYNCH 424). As shown in FIG. 4, both the synchronization channel block (e.g., SYNCH 424) and the read pointer 426 are synchronized using a transmit link macro clock signal (e.g., LM_DIG_TXCLK of table 1). This allows the read pointer 426 to follow the write pointer 414 with a certain delay in between. The read pointer 426 outputs a signal that is used to control the output of multiplexer 422, which receives the data to be transmitted from the TX ASYNC FIFO 412. A logic block 428 that implements the!=equality is provided the output of both the read pointer 426 and the synchronization channel block (e.g., SYNCH 424). Logic block 428 processes the two input signals and generates a control signal (e.g., LM_DIG_TXVALID of table 1) indicating whether the data to be transmitted is valid. Although FIG. 4 shows D2D transmit link macro 400 as including certain components arranged in a certain manner, D2D transmit link macro 400 could include additional or fewer components that are arranged differently.

FIG. 5 shows a block diagram of a D2D receive link macro 500 for use with power efficient bidirectional die-to-die communication systems and methods. On the receive side, the serialized data, received via an interposer (or a similar structure), is de-serialized using a de-serializer block (not shown). The de-serialized data is then processed by the D2D receive link macro 500. As an example, if the transmit side sent 140 bits after serialization then the D2D receive link macro 500 processes those bits. Table 2 below provides a brief explanation for the various signals (shown in FIG. 5) associated with the D2D receive link macro 500.

TABLE 2

| D2D Receive Link | |
|---|---|
| Marco Signals | Brief Explanation |
| LM_DIG_RXDATA | Data, which has been de-serialized, |
| | received from another die by the D2D |
| | receive link macro. |
| LM_DIG_RXCLK | Receive clock associated with the D2D |
| | receive link macro. |
| LM_DIG_RXVALID | Control signal indicative of whether the |
| | receive data is valid. |
| SOC_CHN_RXDATA | Data provided by the D2D receive link to the |
| | pertinent SoC channel. |
| SOC_CHN_RXVALID | Control signal for the SoC channel indicating |
| | valid receive data. |
| SOC_CHN_RXCLK | Receive clock associated with the |
| | pertinent SoC channel. |
| SOC_CHN_RXREADY | Ready signal from the pertinent SoC |
| | channel to D2D receive link macro. |

With continued reference to FIG. 5, in this example, the D2D receive link macro 500 includes a receive asynchronous FIFO (RX ASYNC FIFO 512), which is used to receive the de-serialized data (e.g., LM_DIG_TXDATA of table 2). The D2D receive link macro 500 further includes a write pointer 514, a synchronization channel block (e.g., SYNCH 524), and a read pointer 526. The write pointer 514 points to the data in the RX ASYNC FIFO 512 and it is synchronized with the read pointer 526 using the synchronization channel block (e.g., SYNCH 524). As shown in FIG. 5, both the synchronization channel block and the read pointer 526 are synchronized using a SoC channel receive clock signal (e.g., SOC_CHN_RXCLK of table 2). The read pointer 526 outputs a signal that is used to control the output of multiplexer 522, which receives the data from the RX ASYNC FIFO 512 and outputs the received data to the respective SoC channel (e.g., as SOC_CHN_RXDATA of table 2). In terms of reading the data, the read side of the RX ASYNC FIFO 512 waits for all of the pointers to advance to the same value before reading out the location of the RX ASYNC FIFO 412. A logic block 528 that implements the!=equality is provided the output of both the read pointer 526 and the synchronization channel block (e.g., SYNCH 524). Logic block 528 processes the two input signals and generates a control signal (e.g., SOC_CHN_RXVALID of table 2) indicating whether the data for the respective SoC channel is valid. Although FIG. 5 shows D2D receive link macro 500 as including certain components arranged in a certain manner, D2D receive link macro 500 could include additional or fewer components that are arranged differently.

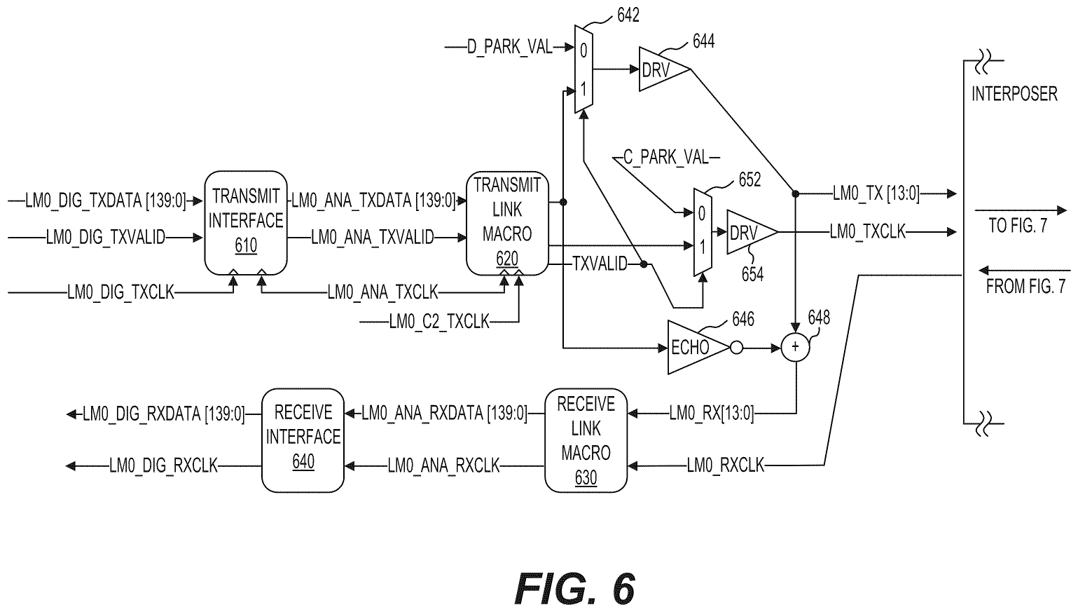

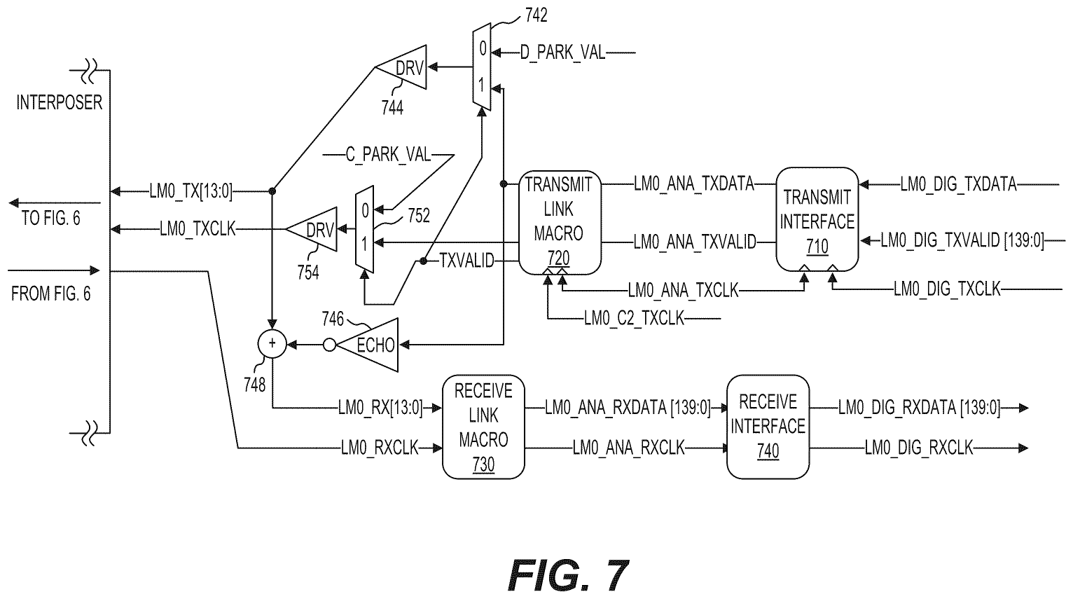

FIGS. 6 and 7 show a block diagram of a power efficient bidirectional die-to-die (PEBD) communication system with parking of transmit drivers and clock drivers. FIG. 6 shows one side of the PEBD communication system and FIG. 7 shows the other side of the PEBD communication system. The two sides are mirror images of each other. As an example, one side (shown in FIG. 6) could be included as part of die 110 of FIG. 1 and the other side (shown in FIG. 7) could be included as part of die 150 of FIG. 1. In this example, the PEBD communication system includes a transmit interface 610 that is shown as being capable of processing 140 bits of data, a valid signal, and a transmit clock. These signals include: LM0_DIG_TXDATA[139:0], LM0_DIG_TXVALID, and LM0_DIG_TXCLK. The PEBD communication system further includes a transmit link macro 620 that receives the output from the transmit interface 610. The signals received by the transmit link macro include LM0_ANA_TXDATA[139:0], LM0_ANA_TXVALID, LM0_ANA_TXCLK. The annotation ANA means that these signals correspond to the analog macro aspect of the link macro and the annotation DIG means that these signals correspond to the digital macro aspect of the link macro. In addition, transmit link macro 620 receives a clock gating signal (LM0_C2_TXCLK), which is used for clock gating, as explained later.

With continued reference to FIG. 6, the data output of the transmit link macro 620 is provided to a first input of a multiplexer 642 and to an echo canceller (ECHO 646). The second input of multiplexer 642 is coupled to receive a voltage level corresponding to a parking value (D_PARK_VAL). The voltage level can be the ground voltage or a voltage supply level (e.g., VDD) that is derived from supply voltage that supplies power to the PEBD communication system. Multiplexer 642 is controlled by the TXVALID signal, which is received from the transmit interface 610. The output of the multiplexer 642 is coupled to a transmit driver (DRV 644), which is used to drive the received signal from the transmit link macro 620, as long as the TXVALID signal has a first value (e.g., a logical 1) that allows the transmission. In case the TXVALID signal has a second value (e.g., a logical 0) that is the opposite of the first value, the multiplexer 642 couples the voltage level corresponding to the parking value (D_PARK_VAL) to the transmit driver (DRV 644), which effectively parks the transmit driver to the voltage level.

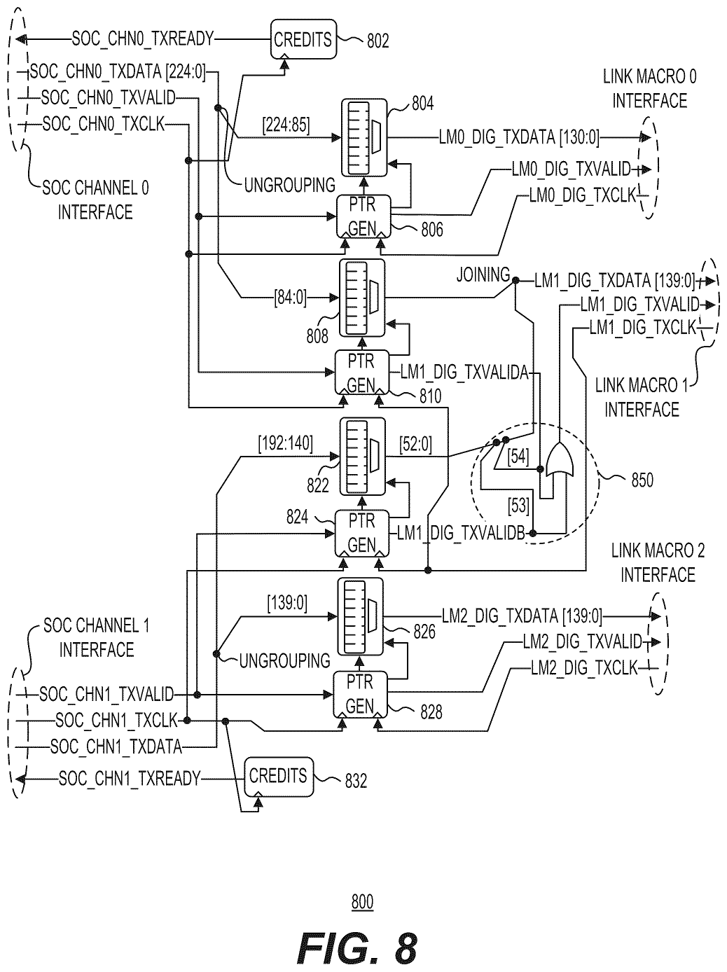

Still referring to FIG. 6, the clock signal output by the transmit link macro 620 is provided to a first input of another multiplexer 652. The second input of the multiplexer 652 is coupled to receive a voltage level corresponding to a parking value (C_PARK_VAL). The voltage level can be the ground voltage or a voltage supply level (e.g., VDD) that is derived from supply voltage that supplies power to the PEBD communication system. Multiplexer 652 is also controlled by the TXVALID signal, which is received from the transmit interface 610. The output of the multiplexer 652 is coupled to a clock driver (DRV 654), which is used to drive the received clock signal from the transmit link macro 620, as long as the TXVALID signal has a first value (e.g., a logical 1) that allows the clock signal to be driven. In case the TXVALID signal has a second value (e.g., a logical 0) that is the opposite of the first value, the multiplexer 652 couples the voltage level corresponding to the parking value (C_PARK_VAL) to the clock driver (DRV 654), which effectively parks the clock driver (DRV 654) to the voltage level corresponding to the D_PARK_VAL signal. In addition, using clock gating, the clock can be disabled (e.g., using the signal LM0_C2_TXCLK) when no data is flowing through the data path (e.g., from transmit link macro 620 towards the second die). Additional detailed examples of clock gating are provided with respect to FIGS. 8-11.

With continued reference to FIG. 6, the PEBD communication system further includes a receive link macro 630 and a receive interface 640. As explained earlier, to enable bidirectional communication along a shared route, the output of transmit link macro 620 is provided to echo canceller (ECHO 646). The signal that is received over the shared route is summed using summer 648, which sums the negative (inverted) signal that is being transmitted over the shared route, resulting in the receive link macro receiving the signal that should be received (LM0_RX[13:0]) on this side of the PEBD communication system from the other side. Additional details regarding echo cancellation are provided with respect to FIG. 2 and the related description. Receive link macro 630 also receive the clock signal (LM0_RXCLK). In this example, the PEBD communication system also includes a receive interface 640 that is shown as being capable of processing 140 bits of data (LM0_ANA_RXDATA[139:0]) and a receive clock (LM0_ANA_RXCLK). The PEBD communication system further includes a receive interface 640 that receives the output from the receive link macro 630. The signals output by the receive link macro 630 include LM0_DIG_RXDATA[139:0] and LM0_DIG_TXCLK. The annotation ANA means that these signals correspond to the analog macro aspect of the link macro and the annotation DIG means that these signals correspond to the digital macro aspect of the link macro. Although FIG. 6 shows the PEBD communication system as including certain components arranged in a certain manner, the PEBD communication system could include additional or fewer components that are arranged differently.

FIG. 7 shows a block diagram of a data and clock path 700 of the other side of the PEBD communication system. This side of the PEBD communication system includes a mirror image of the components on the side described with respect to FIG. 6. In this example, this side of the PEBD communication system includes a transmit interface 710 that is shown as being capable of processing 140 bits of data, a valid signal, and a transmit clock. These signals include: LM0_DIG_TXDATA[139:0], LM0_DIG_TXVALID, and LM_DIG_TXCLK. The PEBD communication system further includes a transmit link macro 720 that receives the output from the transmit interface 710. The signals received by the transmit link macro include LM0_ANA_TXDATA[139:0], LM0_ANA_TXVALID, LM0_ANA_TXCLK. The annotation ANA means that these signals correspond to the analog macro aspect of the link macro and the annotation DIG means that these signals correspond to the digital macro aspect of the link macro. In addition, transmit link macro 720 receives a clock gating signal (LM0_C2_TXCLK), which is used for clock gating, as explained later.

With continued reference to FIG. 7, the data output of the transmit link macro 720 is provided to a first input of a multiplexer 742 and to an echo canceller (ECHO 746). The second input of multiplexer 742 is coupled to receive a voltage level corresponding to a parking value (D_PARK_VAL). As before, the voltage level can be the ground voltage or a voltage supply level (e.g., VDD) that is derived from supply voltage that supplies power to the PEBD communication system. Multiplexer 742 is controlled by the TXVALID signal, which is received from the transmit interface 710. The output of the multiplexer 742 is coupled to a transmit driver (DRV 744), which is used to drive the received signal from the transmit link macro 720, as long as the TXVALID signal has a first value (e.g., a logical 1) that allows the transmission. In case the TXVALID signal has a second value (e.g., a logical 0) that is the opposite of the first value, the multiplexer 742 couples the voltage level corresponding to the parking value (D_PARK_VAL) to the transmit driver (DRV 744), which effectively parks the transmit driver to the voltage level.

Still referring to FIG. 7, the clock signal output by the transmit link macro 720 is provided to a first input of another multiplexer 752. The second input of the multiplexer 752 is coupled to receive a voltage level corresponding to a parking value (C_PARK_VAL). The voltage level can be the ground voltage or a voltage supply level (e.g., VDD) that is derived from supply voltage that supplies power to the PEBD communication system. Multiplexer 752 is also controlled by the TXVALID signal, which is received from the transmit interface 710. The output of the multiplexer 752 is coupled to a clock driver (DRV 754), which is used to drive the received clock signal from the transmit link macro 720, as long as the TXVALID signal has a first value (e.g., a logical 1) that allows the clock signal to be driven. In case the TXVALID signal has a second value (e.g., a logical 0) that is the opposite of the first value, the multiplexer 752 couples the voltage level corresponding to the parking value (C_PARK_VAL) to the clock driver (DRV 754), which effectively parks the clock driver (DRV 754) to the voltage level corresponding to the D_PARK_VAL signal. In addition, using clock gating, the clock can be disabled (e.g., using the signal LM0_C2_TXCLK) when no data is flowing through the data path (e.g., from transmit link macro 720 towards the second die). Additional detailed examples of clock gating are provided with respect to FIGS. 8-11.

With continued reference to FIG. 7, this side of the PEBD communication system, similar to the other side (described with respect to FIG. 6), further includes a receive link macro 730 and a receive interface 740. As explained earlier, to enable bidirectional communication along a shared route, the output of transmit link macro 720 is provided to echo canceller (ECHO 746). The signal that is received over the shared route is summed using summer 748, which sums the negative (inverted) signal that is being transmitted over the shared route, resulting in the receive link macro receiving the signal that should be received (LM0_RX[13:0]) on this side of the PEBD communication system from the other side. Additional details regarding echo cancellation are provided with respect to FIG. 2 and the related description. Receive link macro 730 also receives the clock signal (LM0_RXCLK). In this example, the PEBD communication system also includes a receive interface 740 that is shown as being capable of processing 140 bits of data (LM0_ANA_RXDATA[139:0]) and a receive clock (LM0_ANA_RXCLK). The receive interface 740 receives the output from the receive link macro 730. The signals output by the receive link macro 730 include LM0_DIG_RXDATA[139:0] and LM0_DIG_TXCLK. The annotation ANA means that these signals correspond to the analog macro aspect of the link macro and the annotation DIG means that these signals correspond to the digital macro aspect of the link macro. Although FIG. 7 shows the other side of the PEBD communication system as including certain components arranged in a certain manner, the PEBD communication system could include additional or fewer components that are arranged differently. Moreover, the voltage level corresponding to D_PARK_VAL for parking the transmit drivers need not be the same as the voltage level corresponding to C_PARK_VAL for parking the clock drivers.

FIG. 8 shows an example set of D2D transmit link macros 800 for use with the power efficient bidirectional die-to-die communication systems. The set of D2D transmit link macros 800 can be used to receive data from one or more SoC channels and transfer the data via D2D links. As described earlier, the D2D transmit link macros can process the data received from the SoC channels, and after serialization, the data can be transmitted via D2D links to another die via an interposer or similar structure. In this example, the set of D2D transmit link macros 800 assumes a lack of perfect alignment in terms of the bandwidth of the pertinent SoC channel and the bandwidth offered by the D2D transmit link macro. As an example, D2D transmit link macros 800 can be implemented with similar components as described earlier with respect to D2D transmit link macro 400 of FIG. 4 with additional logic clock gating and other functions, including ungrouping, grouping, splitting, and joining. In terms of ungrouping, as an example a specific SoC channel having a bandwidth that exceeds the bandwidth of a single D2D transmit link macro can be ungrouped for transport across joined D2D transmit link macros. At the receive side, the ungrouped SoC channel can be grouped using split D2D receive link macros. In this example, to enable grouping and ungrouping, all of the FIFOs at both the transmit side and the receive side are initialized at the same time when the D2D nodes are initialized upon the SoC powering up.

With continued reference to FIG. 8, in this example, the set of D2D transmit link macros 800 is configured to transmit data from two SoC channels: SOC_CH_0 and SOC_CH_1. This example assumes that SOC_CH_0 has a bandwidth of 225 bits in terms of the data that requires transmission and that SOC_CH_1 has a bandwidth of 193 bits in terms of the data that requires transmission. In this example, the set of D2D transmit link macros 800 includes three modular D2D transmit link macros. In this example, each of the set of D2D transmit link macros 800 supports 14 data lanes, where each lane is capable of handling 10 bits (e.g., similar to D2D transmit link macro 400 of FIG. 4), resulting in the bandwidth capacity of 140 bits. Notably, in this example, each of the SoC channels has a bandwidth that exceeds the bandwidth capacity of a single D2D transmit link macro. To allow for transmission of data, the data from the first SoC channel (e.g., SOC_CH_0) is ungrouped into a first group of data and a second group of data. Similarly, the data from the second SoC channel (SOC_CH_1) is ungrouped into a third group of data and a fourth group of data. In this example, a first D2D transmit link macro is configured to transmit the first group of data, a second D2D transmit link macro is configured to transmit both the second group of data and the third group of data, and a third modular D2D transmit link macro is configured to transmit the fourth group of data.

Still referring to FIG. 8, the data output by each of the set of D2D transmit link macros 800 is serialized prior to the transmission using a serializer block (not shown). Similar signals as described earlier with respect to table 1 in the context of FIG. 4 are associated with the set of D2D transmit link macros 800. In this example, each set of D2D transmit link macros 800 includes some of the same circuitry as described earlier with respect to D2D transmit link macro 400. As an example, the set of D2D transmit link macros 800 includes circuitry for flow control, such as credits 802 and 832 (similar to credits 416 of FIG. 4). The set of D2D transmit link macros 800 further includes circuitry associated with FIFOs (e.g., FIFO blocks 804, 808, 822, and 826) and pointer generation (e.g., pointer generation blocks 806, 810, 824, and 828). Each of the FIFOs included in FIFO blocks 804, 808, 822, and 828 waits for all the associated pointers to advance to the same value before reading out the location of the FIFO. The set of transmit link macros 800 further includes control logic 850 for generating signals that permit clock gating and the joining of data for transmission by a shared D2D transmit link macro. Clock gating allows one to disable the clock and the data when there isn't any more data flowing through the data path. Since the flow of data is bidirectional, the clock gating logic is included in the set of transmit link macros 800 on each side of that die coupled via the D2D links. Advantageously, clock gating can be enforced independently for each side in terms of the transmission of the data to the other side. This allows power savings in instances where the data is flowing in only one direction, but is paused in the opposite direction.

If data is flowing, then a valid signal is inserted into the data path for each SoC bus that is ungrouped. As shown in FIG. 8, bits 53 and 54 carry the valid signal for the two SoC channels that were ungrouped. Using control logic 850, these bits are processed to validate the data and generate the LM1_DIG_TXVALID signal for transmission to the receive side. Although FIG. 8 shows the set of D2D transmit link macros 800 as having a certain number of components that are arranged in a certain manner, the set of D2D transmit link macros 800 may include additional or fewer components that are arranged differently.

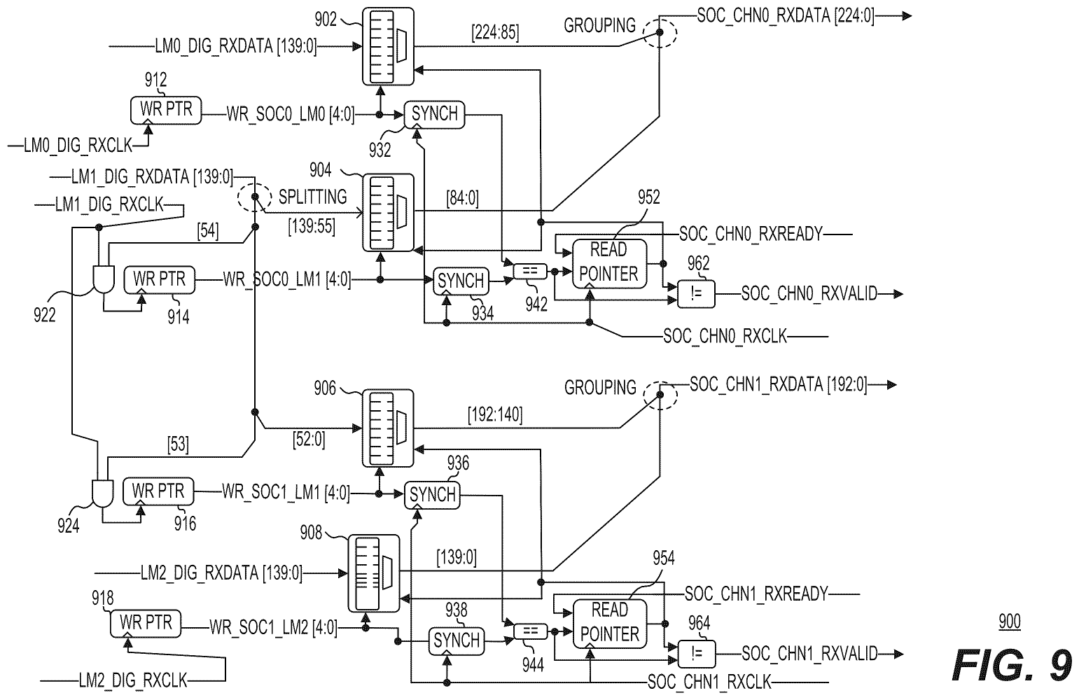

FIG. 9 shows an example set of D2D receive link macros 900 for use with the set of D2D transmit link macros 800 of FIG. 8. The set of D2D receive link macros 900 can be used to receive data via the D2D links. As described earlier, the D2D receive link macros can process the data received from D2D links, and after de-serialization, the data can be transferred to the SoC channels within the SoC (or a similar system). As an example, each of the set of D2D receive link macros 900 can be implemented with similar components as described earlier with respect to D2D receive link macro 500 of FIG. 5 with the additional logic for clock gating, splitting, and grouping. In this example, the set of D2D receive link macros 900 includes three D2D receive link macros. In this example, each of the set of D2D receive link macros 900 supports 14 data lanes, where each lane is capable of handling 10 bits, resulting in a bandwidth capacity of 140 bits. The first group of data corresponding to SoC channel 0 (SOC_CHN0) is received via one of the set of D2D receive link macros 900. The second group of data (corresponding to SoC channel 0), which was ungrouped at the transmit side, is received by one of the second set of D2D receive link macros 900. The third group of data (corresponding to SoC channel 1 (SOC_CHN1)) is received via one of the second set of D2D receive link macros, and the fourth group of data (corresponding to SoC channel 1) is received by one of the third set of D2D receive link macros 900.

With continued reference to FIG. 9, similar signals as described earlier with respect to table 2 in the context of FIG. 5 are associated with the set of D2D receive link macros 900. In this example, each set of D2D receive link macros 900 includes some of the same circuitry as described earlier with respect to D2D receive link macros 500 of FIG. 5. As an example, the set of D2D receive link macros 900 includes circuitry associated with FIFOs (e.g., FIFO blocks 902, 904, 906, and 908) and write pointer generation circuitry (e.g., WR PTR blocks 912, 914, 916, and 918). The set of D2D receive link macros 900 further includes clock gating control logic (e.g., AND gates 922 and 924) for generating clock gating signals that are used for clock gating. As an example, when bit 54 received from the transmit side is logical zero then AND gate 922 does not output a logic high preventing the clocking of the write pointer (WR PTR 914). Similarly, when bit 54 received from the transmit side is logical zero then AND gate 924 does not output a logic high preventing the clocking of the write pointer (WR PTR 916).

In this example, the same control logic is also used for splitting of the data for processing by a shared D2D receive link macro. The set of D2D receive link macros 900 further includes synchronization channel blocks (e.g., SYNCH 932, SYNCH 934, SYNCH 936, and SYNCH 938), and read pointers (e.g., READ POINTER 952 and READ POINTER 954). As explained earlier with respect to FIG. 5, each respective write pointer points to the data in the respective receive FIFO and it is synchronized with the respective read pointer using the respective synchronization channel block. In terms of reading the data, as described earlier with respect to FIG. 5, the receive side waits for all of the pointers to advance to the same value before reading out the location of the receive FIFO. To allow for the grouping of the data received from different SoC channels, logic blocks 942 and 944 that implement the equality operation are used at the input of the respective read pointer. Additional logic blocks 962 and 194 that implement the!=equality are provided the output of both the respective read pointer and the respective logic blocks 942 and 944. Although FIG. 9 shows the set of D2D receive link macros 900 as having a certain number of components that are arranged in a certain manner, the set of D2D receive link macros 900 may include additional or fewer components that are arranged differently.

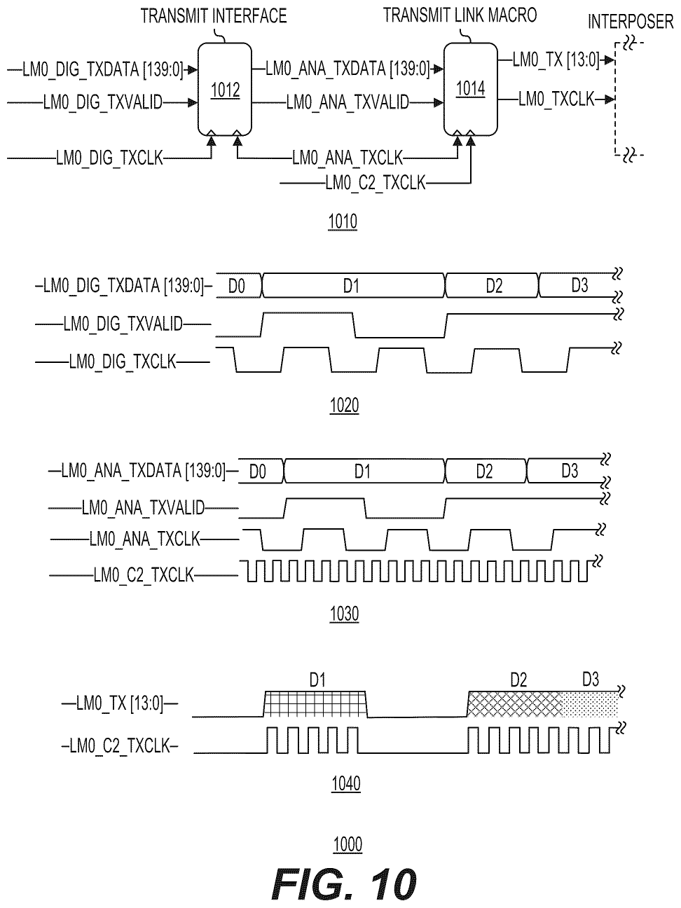

FIG. 10 shows waveform diagrams 1020, 1030, and 1040 associated with clock gating explained with respect to FIGS. 8 and 9. In order to explain the data flow, a simplified transmit side 1010 is shown with a transmit interface 1012 and a transmit link macro 1014, which is referred to as LM0 as part of the signals shown in the waveform diagrams. Waveform diagrams 1020 correspond to the data signals received by the transmit interface 1012 from an SoC channel interface and a transmit clock signal. These signals include: LM0_DIG_TXDATA[139:0], LM0_DIG_TXVALID, and LM0_DIG_TXCLK. Waveform diagrams 1030 correspond to the signals received by transmit link macro 1014 from the transmit interface 1012. These signals include: LM0_ANA_TXDATA[139:0], LM0_ANA_TXVALID, LM0_ANA_TXCLK, and LM0_C2_TXCLK. The annotation ANA means that these correspond to the analog macro aspect of the link macro.

With continued reference to FIG. 10, waveform diagrams 1040 show the signals being transmitted by transmit link macro 1014 for serialization and then transport via D2D links (e.g., via an interposer). These signals include: LM0_TX[13:0] and LM0_TXCLK. Waveform diagram 1040 shows the impact of the clock gating on clock signal (LM0_C2_RXCLK) which is clock gated, resulting in no data transmission.

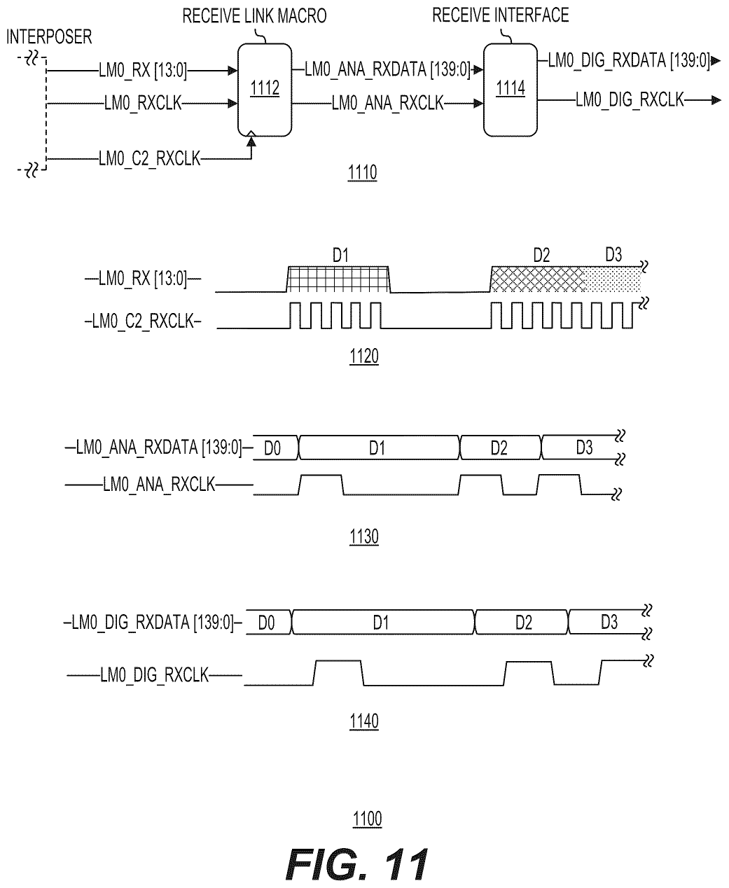

FIG. 11 shows waveform diagrams 1120, 1130, and 1140 associated with clock gating explained with respect to FIGS. 8 and 9. Waveform diagrams 1120, 1130, and 1140 are used to illustrate the data flow along with related signals, including clock signals, for the receive side. In order to explain the data flow, a simplified receive side 1110 is shown as including a receive link macro 1112, which is referred to as LM0 as part of the signals shown in the waveform diagrams, and a receive interface 1114. Waveform diagrams 1120 correspond to the data and clock signals received by the receive link macro 1112 after the serialized signals transmitted via the D2D links have been de-serialized. These signals include: LM0_RX[13:0], LM0_RXCLK, and LM0_C2_RXCLK. Waveform diagram 1120 shows the impact of the clock gating on clock signal (LM0_C2_RXCLK) which is clock gated, resulting in no data transmission.

With continued reference to FIG. 11, waveform diagrams 1130 correspond to the signals received by receive interface 1114 from the receive link macro 1112. These signals include: LM0_ANA_RXDATA[139:0] and LM0_ANA_RXCLK. Once again, the annotation ANA means that these correspond to the analog macro aspect of the link macro. Waveform diagrams 1140 show the signals being provided by receive interface 1114 to an SoC channel. These signals include: LM0_DIG_RXDATA[139:0] and LM0_DIG_RXCLK.

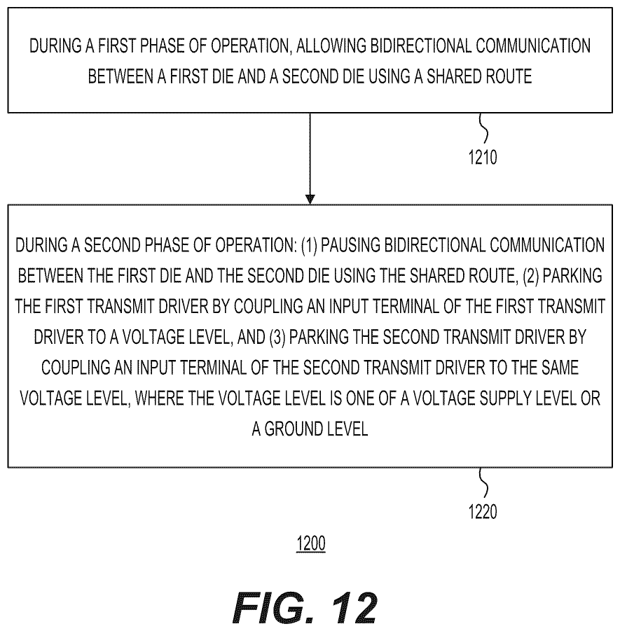

FIG. 12 shows a flow chart 1200 of an example method for bidirectional communication between a first die and a second die in a multi-die system. In this example, the first die comprises a first transmit driver coupled to a first node of a shared route between the first die and the second die, and where the second die comprises a second transmit driver coupled to a second node of the shared route. As an example, the first die may be 110 of FIG. 1 and the second die may be 150 of FIG. 2. The first driver (e.g., TX DRV 214 of FIG. 2 or transmit driver (DRV 644 of FIG. 6)) may be coupled via node N1 to the shared route and the second driver (e.g., TX DRV 254 of FIG. 2 or transmit driver (DRV 744 of FIG. 7)) may be coupled via node N2 to the shared route. In this example, the steps associated with this example can be performed using the power efficient bidirectional communication systems described with respect to FIGS. 1-11. Step 1210 includes during a first phase of operation, allowing bidirectional communication between the first die and the second die using the shared route. In one example, using the transmit link macros and the receive link macros described earlier with respect to FIG. 6 and other figures, bidirectional communication may be achieved.

Step 1220 includes during a second phase of operation: (1) pausing bidirectional communication between the first die and the second die using the shared route, (2) parking the first transmit driver by coupling an input terminal of the first transmit driver to a voltage level, and (3) parking the second transmit driver by coupling an input terminal of the second transmit driver to the same voltage level, where the voltage level is one of a voltage supply level or a ground level. The step related to parking the second transmit driver can be performed as explained earlier with respect to FIGS. 6 and 7. As explained earlier with respect to FIG. 6, the data output of the transmit link macro 620 of FIG. 6 is provided to a first input of a multiplexer 642 and to an echo canceller (ECHO 646). The second input of multiplexer 642 of FIG. 6 is coupled to receive a voltage level corresponding to a parking value (D_PARK_VAL). The voltage level can be the ground voltage or a voltage supply level (e.g., VDD) that is derived from supply voltage that supplies power to the PEBD communication system. Multiplexer 642 of FIG. 6 is controlled by the TXVALID signal, which is received from the transmit interface 610 of FIG. 6. The output of the multiplexer 64 of FIG. 6 2 is coupled to a transmit driver (DRV 644 of FIG. 6), which is used to drive the received signal from the transmit link macro 620 of FIG. 6, as long as the TXVALID signal has a first value (e.g., a logical 1) that allows the transmission. In case the TXVALID signal has a second value (e.g., a logical 0) that is the opposite of the first value, the multiplexer 642 of FIG. 6 couples the voltage level corresponding to the parking value (D_PARK_VAL) to the transmit driver (DRV 644 of FIG. 6), which effectively parks the transmit driver to the voltage level.

The step related to parking the second transmit driver can be performed as explained earlier with respect to FIGS. 6 and 7. As explained earlier with respect to FIG. 7, the output of the multiplexer 742 of FIG. 7 is coupled to a transmit driver (DRV 744 of FIG. 7), which is used to drive the received signal from the transmit link macro 720 of FIG. 7, as long as the TXVALID signal has a first value (e.g., a logical 1) that allows the transmission. In case the TXVALID signal has a second value (e.g., a logical 0) that is the opposite of the first value, the multiplexer 742 of FIG. 7 couples the voltage level corresponding to the parking value (D_PARK_VAL) to the transmit driver (DRV 744 of FIG. 7), which effectively parks the transmit driver to the voltage level. Although FIG. 12 shows a certain number of steps performed in a certain order, additional or fewer steps in a different order may be performed as part of the method described with respect to flow chart 1200.

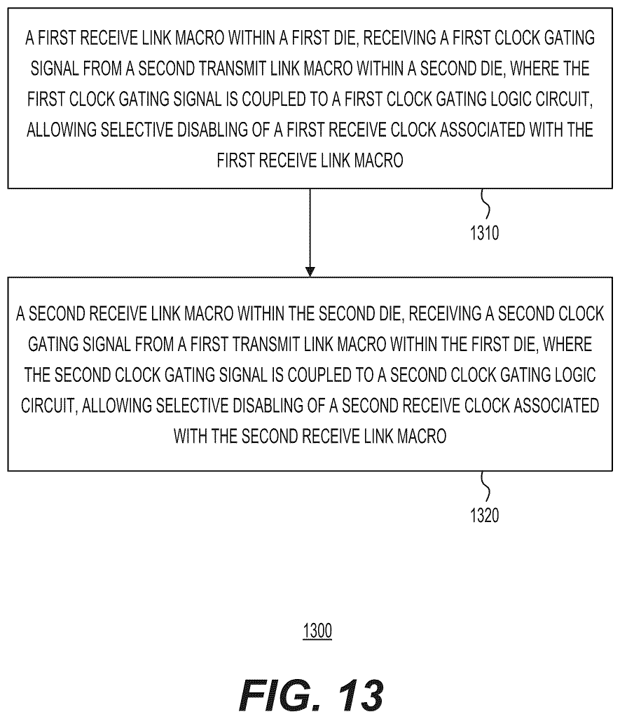

FIG. 13 shows a flow chart 1300 of an example method for bidirectional communication between a first die and a second die in a multi-die system. In this example, the steps associated with this example can be performed using the power efficient bidirectional communication systems described with respect to FIGS. 1-11. As an example, the first die may be 110 of FIG. 1 and the second die may be 150 of FIG. 2. Step 1310 includes a first receive link macro within the first die, receiving a first clock gating signal from a second transmit link macro within the second die, where the first clock gating signal is coupled to a first clock gating logic circuit, allowing selective disabling of a first receive clock associated with the first receive link macro. In one example, FIG. 9 shows an example set of receive link macros with clock gating for use with power efficient bidirectional die-to-die communication. The clock gating circuit includes the clock gating logic (e.g., AND gate 922 or 924) and related logic at the receive link macro for decoding bit 53 or bit 54 received along with the data. Waveform diagram 1120 of FIG. 11 shows the impact of the clock gating on clock signal (LM0_C2_RXCLK) which is clock gated, resulting in no data transmission.

Step 1320 includes a second receive link macro within the second die, receiving a second clock gating signal from a first transmit link macro within the first die, where the second clock gating signal is coupled to a second clock gating logic circuit, allowing selective disabling of a second receive clock associated with the second receive link macro. In one example, FIG. 9 shows an example set of receive link macros with clock gating for use with power efficient bidirectional die-to-die communication. The clock gating circuit includes the clock gating logic (e.g., AND gate 922 or 924) and related logic at the receive link macro for decoding bit 53 or bit 54 received along with the data. Waveform diagram 1120 of FIG. 11 shows the impact of the clock gating on clock signal (LM0_C2_RXCLK) which is clock gated, resulting in no data transmission. Although FIG. 13 shows a certain number of steps performed in a certain order, additional or fewer steps in a different order may be performed as part of the method described with respect to flow chart 1300.

In conclusion, the present disclosure relates to a method for bidirectional communication between a first die and a second die in a multi-die system. The first die may comprise a first transmit driver coupled to a first node of a shared route between the first die and the second die, and the second die may comprise a second transmit driver coupled to a second node of the shared route. The method may include, during a first phase of operation, allowing bidirectional communication between the first die and the second die using the shared route.

The method may further include during a second phase of operation: (1) pausing bidirectional communication between the first die and the second die using the shared route, (2) parking the first transmit driver by coupling an input terminal of the first transmit driver to a voltage level, and (3) parking the second transmit driver by coupling an input terminal of the second transmit driver to the same voltage level, where the voltage level is one of a voltage supply level or a ground level.

The method may further include during the second phase of operation, instead of parking each of the first transmit driver and the second transmit driver to the voltage level, placing each of the first transmit driver and the second transmit driver into a high impedance state. The first die may include a first echo canceller and a first receive driver. The method may further comprise, using the first echo canceller, subtracting a first transmitted signal from the first die from a first received signal from the second die. The second die may include a second echo canceller and a second receive driver. The method may further comprise, using the second echo canceller, subtracting a second transmitted signal from the second die from a second received signal from the first die.

The method may further include receiving a first clock gating signal from a second transmit link macro from within the second die, where the first clock gating signal is coupled to a first clock gating logic circuit within the first die, allowing selective disabling of a first receive clock associated with a first receive link macro within the first die. The method may further include receiving a second clock gating signal from a first transmit link macro from within the first die, where the second clock gating signal is coupled to a second clock gating logic circuit within the second die, allowing selective disabling of a second receive clock associated with a second receive link macro within the second die.

The first clock gating signal may be encoded as a first bit and transmitted with first data from the second transmit link macro from within the second die. The second clock gating signal may be encoded as a second bit and transmitted with second data from the first transmit link macro within the first die.

In another example, the present disclosure relates to a method for bidirectional communication between a first die and a second die in a multi-die system. The method may include a first receive link macro within the first die, receiving a first clock gating signal from a second transmit link macro within the second die, where the first clock gating signal is coupled to a first clock gating logic circuit, allowing selective disabling of a first receive clock associated with the first receive link macro.

The method may further include a second receive link macro within the second die, receiving a second clock gating signal from a first transmit link macro within the first die, where the second clock gating signal is coupled to a second clock gating logic circuit, allowing selective disabling of a second receive clock associated with the second receive link macro.

The first clock gating signal may be encoded as a first bit and transmitted with first data from the second transmit link macro within the second die. The second clock gating signal may be encoded as a second bit and transmitted with second data from the first transmit link macro within the first die.

The first clock gating logic circuit may comprise a first logical AND gate with a first input as the first receive clock and the second input as the first clock gating signal. The second clock gating logic circuit may comprise a second logical AND gate with a first input as the second receive clock and the second input as the second clock gating signal.

In yet another example, the present disclosure relates to a method for bidirectional communication between a first die and a second die in a multi-die system. The first die may comprise a first transmit driver coupled to a first node of a shared route between the first die and the second die and a first clock driver for driving a first clock signal, and the second die may comprise a second transmit driver coupled to a second node of the shared route and a second clock driver. The method may include, during a first phase of operation, allowing bidirectional communication between the first die and the second die using the shared route.

The method may further include during a second phase of operation: (1) pausing bidirectional communication between the first die and the second die using the shared route, (2) parking the first transmit driver by coupling an input terminal of the first transmit driver to a voltage level, (3) parking the second transmit driver by coupling an input terminal of the second transmit driver to the same voltage level, where the voltage level is one of a voltage supply level or a ground level, (4) parking the first clock driver by coupling an input terminal of the first clock driver to the same voltage level, and (5) parking the second clock driver by coupling an input terminal of the second clock driver to the same voltage level.

The method may further include during the second phase of operation, instead of parking each of the first transmit driver and the second transmit driver to the voltage level, placing each of the first transmit driver and the second transmit driver into a high impedance state. The method may further include during the second phase of operation, instead of parking each of the first clock driver and the second clock driver to the voltage level, placing each of the first clock driver and the second clock driver into a high impedance state.

The first die may comprise a first echo canceller and a first receive driver. The method may further comprise, using the first echo canceller, subtracting a first transmitted signal from the first die from a first received signal from the second die. The second die may comprise a second echo canceller and a second receive driver. The method may further comprise, using the second echo canceller, subtracting a second transmitted signal from the second die from a second received signal from the first die.

The method may further include receiving a first clock gating signal from a second transmit link macro from within the second die, where the first clock gating signal is coupled to a first clock gating logic circuit within the first die, allowing selective disabling of a first receive clock associated with a first receive link macro within the first die. The method may further include receiving a second clock gating signal from a first transmit link macro from within the first die, where the second clock gating signal is coupled to a second clock gating logic circuit within the second die, allowing selective disabling of a second receive clock associated with a second receive link macro within the second die.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), or Complex Programmable Logic Devices (CPLDs). In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with, transmission media. Transmission media is used for transferring data and/or instruction to or from a machine. Exemplary transmission media include coaxial cables, fiber-optic cables, copper wires, and wireless media, such as radio waveforms.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A method for bidirectional communication between a first die and a second die in a multi-die system, wherein the first die comprises a first transmit driver coupled to a first node of a shared route between the first die and the second die, and wherein the second die comprises a second transmit driver coupled to a second node of the shared route, the method comprising:
during a first phase of operation, allowing bidirectional communication between the first die and the second die using the shared route; and
during a second phase of operation: (1) pausing bidirectional communication between the first die and the second die using the shared route, (2) parking the first transmit driver by coupling an input terminal of the first transmit driver to a voltage level, and (3) parking the second transmit driver by coupling an input terminal of the second transmit driver to the same voltage level, wherein the voltage level is one of a voltage supply level or a ground level.

2. The method of claim 1, further comprising during the second phase of operation, instead of parking each of the first transmit driver and the second transmit driver to the voltage level, placing each of the first transmit driver and the second transmit driver into a high impedance state.

3. The method of claim 1, wherein the first die comprises a first echo canceller and a first receive driver, wherein the method further comprises, using the first echo canceller, subtracting a first transmitted signal from the first die from a first received signal from the second die.

4. The method of claim 3, wherein the second die comprises a second echo canceller and a second receive driver, wherein the method further comprises, using the second echo canceller, subtracting a second transmitted signal from the second die from a second received signal from the first die.

5. The method of claim 1, further comprising receiving a first clock gating signal from a second transmit link macro from within the second die, wherein the first clock gating signal is coupled to a first clock gating logic circuit within the first die, allowing selective disabling of a first receive clock associated with a first receive link macro within the first die.

6. The method of claim 5, further comprising receiving a second clock gating signal from a first transmit link macro from within the first die, wherein the second clock gating signal is coupled to a second clock gating logic circuit within the second die, allowing selective disabling of a second receive clock associated with a second receive link macro within the second die.

7. The method of claim 6, wherein the first clock gating signal is encoded as a first bit and transmitted with first data from the second transmit link macro from within the second die.

8. The method of claim 7, wherein the second clock gating signal is encoded as a second bit and transmitted with second data from the first transmit link macro within the first die.

9. A method for bidirectional communication between a first die and a second die in a multi-die system, the method comprising:
a first receive link macro within the first die, receiving a first clock gating signal from a second transmit link macro within the second die, wherein the first clock gating signal is coupled to a first clock gating logic circuit, allowing selective disabling of a first receive clock associated with the first receive link macro; and
a second receive link macro within the second die, receiving a second clock gating signal from a first transmit link macro within the first die, wherein the second clock gating signal is coupled to a second clock gating logic circuit, allowing selective disabling of a second receive clock associated with the second receive link macro.

10. The method of claim 9, wherein the first clock gating signal is encoded as a first bit and transmitted with first data from the second transmit link macro within the second die.

11. The method of claim 10, wherein the second clock gating signal is encoded as a second bit and transmitted with second data from the first transmit link macro within the first die.

12. The method of claim 9, wherein the first clock gating logic circuit comprises a first logical AND gate with a first input as the first receive clock and the second input as the first clock gating signal.

13. The method of claim 12, wherein the second clock gating logic circuit comprises a second logical AND gate with a first input as the second receive clock and the second input as the second clock gating signal.

14. A method for bidirectional communication between a first die and a second die in a multi-die system, wherein the first die comprises a first transmit driver coupled to a first node of a shared route between the first die and the second die and a first clock driver for driving a first clock signal, and wherein the second die comprises a second transmit driver coupled to a second node of the shared route and a second clock driver, the method comprising:
during a first phase of operation, allowing bidirectional communication between the first die and the second die using the shared route; and
during a second phase of operation: (1) pausing bidirectional communication between the first die and the second die using the shared route, (2) parking the first transmit driver by coupling an input terminal of the first transmit driver to a voltage level, (3) parking the second transmit driver by coupling an input terminal of the second transmit driver to the same voltage level, wherein the voltage level is one of a voltage supply level or a ground level, (4) parking the first clock driver by coupling an input terminal of the first clock driver to the same voltage level, and (5) parking the second clock driver by coupling an input terminal of the second clock driver to the same voltage level.

15. The method of claim 14, further comprising during the second phase of operation, instead of parking each of the first transmit driver and the second transmit driver to the voltage level, placing each of the first transmit driver and the second transmit driver into a high impedance state.

16. The method of claim 15, further comprising during the second phase of operation, instead of parking each of the first clock driver and the second clock driver to the voltage level, placing each of the first clock driver and the second clock driver into a high impedance state.

17. The method of claim 14, wherein the first die comprises a first echo canceller and a first receive driver, wherein the method further comprises, using the first echo canceller, subtracting a first transmitted signal from the first die from a first received signal from the second die.

18. The method of claim 17, wherein the second die comprises a second echo canceller and a second receive driver, wherein the method further comprises, using the second echo canceller, subtracting a second transmitted signal from the second die from a second received signal from the first die.

19. The method of claim 14, further comprising receiving a first clock gating signal from a second transmit link macro from within the second die, wherein the first clock gating signal is coupled to a first clock gating logic circuit within the first die, allowing selective disabling of a first receive clock associated with a first receive link macro within the first die.

20. The method of claim 19, further comprising receiving a second clock gating signal from a first transmit link macro from within the first die, wherein the second clock gating signal is coupled to a second clock gating logic circuit within the second die, allowing selective disabling of a second receive clock associated with a second receive link macro within the second die.
